(19) United States
(12) Patent Application Publication
(10) Pub. No.: US 2017/0004478 A1
(43) Pub. Date: Jan. 5, 2017

(54) System for Point of Sale Data Capture, Reporting and Analysis for the Auditing of Sales Taxes

(71) Applicants: Hector Uriel Velez, San Juan, PR (US); Arturo Micheli, Trujillo Alto, PR (US); Victor Salaman, Caguas, PR (US); Juan Antonio Ramirez, San Juan, PR (US); Ricardo Veguilla, San Juan, PR (US)

(72) Inventors: Hector Uriel Velez, San Juan, PR (US); Arturo Micheli, Trujillo Alto, PR (US); Victor Salaman, Caguas, PR (US); Juan Antonio Ramirez, San Juan, PR (US); Ricardo Veguilla, San Juan, PR (US)

(21) Appl. No.: 15/255,210

(22) Filed: Sep. 2, 2016

Related U.S. Application Data
(63) Continuation of application No. 14/193,947, filed on Feb. 28, 2014.

(51) Int. Cl. G06Q 20/20; G06Q 40/00

(52) U.S. Cl. CPC G06Q 20/207; G06Q 40/10

(57) ABSTRACT

The present disclosure relates to a system for automatically forwarding retail sales transaction information and corresponding sales tax data from individual retailers to a centrally located remote location for auditing tax. More particularly, this invention relates to a system and method for ensuring that substantially all retail transactions upon which sales tax is collected are reported. Further the device or service creates a lottery number that is stored alongside the data collected for the transaction and sends this lottery number, along with additional auxiliary information and forwards the data to a printer.

### RELATED APPLICATIONS

This application claims the benefit of priority of U.S. provisional application 61/770,356, filed on Feb. 28, 2013 and U.S. non-provisional application Ser. No. 14/193,947, filed on Feb. 28, 2014.

### STATEMENT REGARDING FEDERALLY SPONSORED RESEARCH AND DEVELOPMENT

N/A

### BACKGROUND OF THE DISCLOSURE

Technical Field

This invention relates to a system for automatically forwarding retail sales transaction information and corresponding sales tax data from individual retailers to a centrally located remote location for auditing tax. More particularly, this invention relates to a system and method for ensuring that substantially all retail transactions upon which sales tax is collected are reported. Further the device or service creates a lottery number that is stored alongside the data collected for the transaction and sends this lottery number, along with additional auxiliary information and forwards the data to a printer.

Discussion of the Background

Puerto Rico Internal Revenue code of 1994 was amended, to provide, among other things, for a general sales and use tax of 5.5% imposed by the Commonwealth on the sale of a wide range of goods and delivery of various services. The Internal Revenue code of 1994 also authorized each municipal government to impose a municipal sale and use tax of 1.5%. In general, the municipal sales tax has the same tax base, exemptions (except for non-prepared foods) and limitations as provided for the Commonwealth Sales Tax. The Commonwealth Sales Tax is imposed on the sale, use, consumption, and storage of taxable items, which include tangible personal property, taxable services, admission rights and certain other types of transactions covering separable and identifiable taxable items which are sold for a single price, subject to certain exceptions and limitations. The Secretary of the Treasury has the authority to establish by regulation the conditions for exemption from the tax. Certain articles and items, including items purchased for resale by merchants, are currently exempted by the Treasury from the tax. The Commonwealth Sales Tax went into effect on Nov. 15, 2006. Since implemented by the Government of Puerto Rico, total Commonwealth Sales Tax collections have been on average over $90 million per month. In the current collection process, the general guidelines and procedures are as follows:
Merchants and retailers are required to collect the Commonwealth Sales Tax from the consumer; otherwise the consumer is required to pay the tax.
Each merchant and retailer is currently required to file a monthly return detailing all taxable transactions for the prior month no later than the 10^{th} day of each month. Certain large merchants and retailers are required to file their return electronically. Merchants and retailers remit select Municipal and Commonwealth sales and use tax collected during the prior month to several Authorized Collectors designated by the Secretary of the Treasury. Further, the Authorized Collectors are then required to transfer sales and use tax payments to the Treasury and the appropriate Municipalities.

Even when the total Commonwealth Sales Tax collections have been on average over $90 million per month, as mentioned above, this amount only represents approximately between 52% to 65% of the potential sales and use tax revenue. Therefore improving Puerto Rico's sale and use tax collection rate and bringing it up is one of the objectives of the Puerto Rico Department of the Treasury (PRTD). The PRTD is requesting information from potential service providers that can provide a compliance solution to improve the collection rate of the sale and use tax (SUT). One measure for these means is the implemented Tax TAX (IVU) Fiscalization Program called IVU Loto. The purpose of the IVU Loto is to target the tax evasion on behalf of businesses and to increase IVU collections from the current 52% to approximately 70% meaning over $200 millions in annual increased collections for the government. Further with IVU Loto the consumers will make sure to request receipt upon purchase as it will have a lottery number for a participation in a weekly drawing.

Therefore there is a need for a system and method for computing and collecting taxes, more particularly a system and method that properly computes and collects sales and use taxes in compliance with the legal guidelines and restrictions imposed by national governments such as the Puerto Rico.

### SUMMARY OF THE DISCLOSURE

In accordance with one aspect, the present disclosure includes a method and system designated for the collection of services and to capture sales draft data before it is sent to the printer for printing and storing this data within a database with a unique index per data storage incident. The device or service creates a lottery number that is stored alongside the data collected for the transaction and sends this lottery number, along with additional auxiliary information and forwards the data to the printer. In most cases, the lottery number is generated individually within each device, an offline solution programmed to use an algorithm that has a one-in-eight-billion (1 in 8,000,000,000) chance to generate the same number. It also generates a second number, called a Control Number that further diminishes the chance of duplicate data being generated. An additional advantage of this method is that it can also operate as an anti-automated sales suppression device.

Another object of the present disclosure is to provide two different copies of the data: one of the copies becomes a real receipt that the existing printer at the location prints out for the customer, with all of the usual data for the receipt along with the data inserted by the point of sale capture, analysis and reporting device. The point of sale capture, analysis and reporting device copy of the data, a virtual receipt with the same data that was printed out is stored in its memory, ready to be transmitted to a centralized system at a designated time in order to be stored and sorted later on for whatever purposes are specified by the client.

Yet another object of the present disclosure is to provide a point of sale capture, analysis and reporting device that gathers all of the sales and use tax amounts included in the sales transactions processed by Merchants. The system and method, as mentioned, also provides a mechanism to incentivize taxpayers, wherein the incentive comprises a lottery. The point of sale capture, analysis and reporting device also has the logic to print out the lottery numbers, draw number and date in the consumer's receipt.

Another object of the invention is to provide a platform that will interact with technology already in place, which is trusted by all types of merchants, both major and of lesser volume (POS).

The invention itself, both as to its configuration and its mode of operation will be best understood, and additional objects and advantages thereof will become apparent, by the following detailed description of a preferred embodiment taken in conjunction with the accompanying drawing.

The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying drawings, which are incorporated herein, constitute part of the specifications and illustrate the preferred embodiment of the disclosure.

FIG.1 is a block illustration of an exemplary disclosed system for a point of sale data capture, analysis and reporting device;

FIG. 2 is a flowchart illustration of an exemplary embodiment of the communication process between the point of sale data, analysis, and reporting device and the centralized data collection, sorting and forwarding system in accordance with the principles of the present disclosure;

FIG. 3 is a schematic illustration of an exemplary embodiment for the implementation of the point of sale data capture and reporting method via a single TxPort connected to an Electronic cash register via a crossover Ethernet cable;

FIG. 4 is a schematic illustration of an exemplary embodiment for the implementation of the Point of Sale Data Capture and Reporting Method via multiple TxPort's connected to multiple Electronic Cash Registers via a Network Hub;

FIG. 5 is a schematic illustration of an exemplary embodiment for the implementation of the Point of Sale Data Capture and Reporting Method via a single TxPort Server Edition connected to multiple Electronic Cash Registers via a Network Hub;

FIG. 6 is a schematic illustration of an exemplary embodiment for the implementation of the Point of Sale Data Capture and Reporting Method via a Hosted Web Service Stored on the Internet;

FIG. 7 is a schematic illustration of an exemplary embodiment of a receipt from an implementation of a TxPort Device or Service;

FIG. 8 is a schematic illustration of an exemplary embodiment of the TxHub Operational Diagram;

FIG. 9 is a schematic illustration of an exemplary embodiment of the High-level View of the Receipt Processing Queue.

FIG. 10 is a schematic illustration of an exemplary embodiment of the Bundle Validation and Processing.

FIG. 11 is a schematic illustration of an exemplary embodiment of the Receipt Validation Queue.

FIG. 12 is a schematic illustration of an exemplary embodiment of the Receipt Parsing Processing Queue.

FIG. 13 is an exemplary embodiment of the TxController Inheritance Diagram.

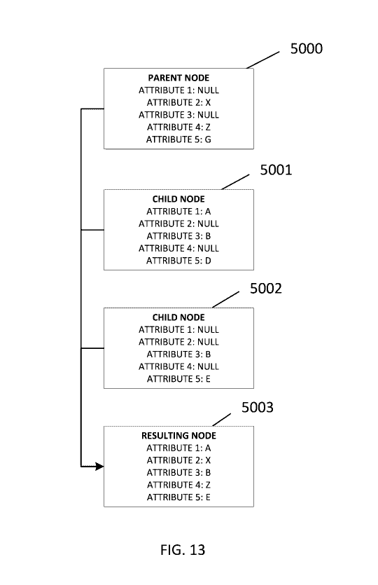

### DETAILED DESCRIPTION

The embodiments of the invention disclosed herein may be implemented, through the use of general-programming languages (such as C or C++). The program code can be disposed in any known computer-readable medium including semiconductor, magnetic disk, or optical disk (such as CD-ROM, DVD-ROM). As such, the code can be transmitted over communication networks including the Internet.

In the present disclosure, the terms “computer program medium” and “computer-usable medium” are used to generally refer to media such as a removable storage unit or a hard disk drive. Computer program medium and computer-usable medium can also refer to memories, such as system memory and graphics memory which can be memory semiconductors (e.g., DRAMs, etc.). These products are examples of how to provide software to a computer system.

The embodiments are also directed to computer products comprising software stored on any computer-usable medium. Such software, when executed in one or more data processing devices, causes a data processing device(s) to operate as described herein or, allows for the synthesis and/or manufacture of computing devices (e.g., ASICs, or processors) to perform embodiments described herein. Embodiments employ any computer-usable or -readable medium, and any computer-usable or -readable storage medium known now or in the future. Examples of computer-usable or computer-readable mediums may include, but are not limited to, primary storage devices (e.g., any type of random access memory or read-only memory), secondary storage devices (e.g., hard drives, floppy disks, CD ROMS, ZIP disks, tapes, magnetic storage devices, optical storage devices, MEMS, nanotechnological storage devices, etc.), and communication mediums (e.g., wired and wireless communications networks, local area networks, wide area networks, intranets, etc.). Further the communication medium may include (i) satellite channels; (ii) fiber optic cables; (iii) telephone lines; (iv) RF channels; and (v) microwave channels.

For purposes of this discussion, the term “module” may include at least one of software, firmware, and hardware (such as one or more circuits, microchips, or devices, or any combination thereof), and any combination thereof. In addition, it will be understood that each module may include one or more components within an actual device, and each component that forms a part of the described module can function either cooperatively or independently of any other component forming a part of the module. Conversely, multiple modules described herein may represent a single component within an actual device. Further, components within a module may be in a single device or distributed among multiple devices in a wired or wireless manner.

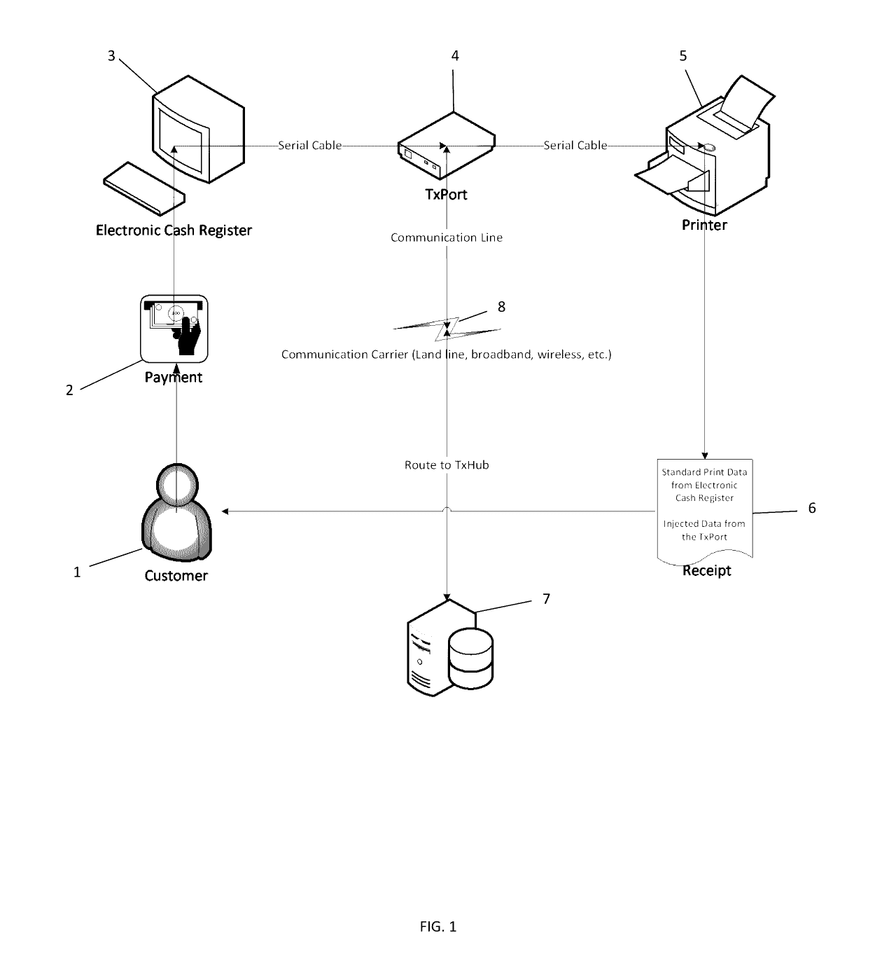

FIG. 1 The Point of Sale Data Capture, Analysis, and Reporting Device (“TxPort”) is 4a physical device that is connected between an existing Electronic Cash Register 3 at a location, and a Printer 5 that was previously connected to that Electronic Cash Register 3. For the purposes of this description, an Electronic Cash Register 3 is a computerized system that can range from a simple, single-purpose device to a sophisticated multi-processor device that allows the merchant to compute costs for sales and services and which may also control a cash drawer for the merchant to store bank notes, sales drafts, and authorization slips.

The TxPort 4 is a flexible device, able to be programmed and configured from a remote configuration authority (the TxController, which will be defined later in this document as a component of the centralized data hub, the TxHub). This configuration authority is able to program the TxPort 4 for the device to recognize the kind of data it needs to store and which data it needs to inject into a printing operation. The configuration authority also manages the methods the TxPort 4 will use to obtain such data and how to present the data to the Printer 5, along with the communication schedule and method for forwarding the stored data to the centralized data gathering system 7. Finally, and just as important, the configuration authority defines which data does not need to be stored within the TxPort 4.

Once the TxPort 4 is installed between the Electronic Cash Register 3 and its Printer 5, the TxPort 4 receives the data that the Printer would have received from the Electronic Cash Register. In order to accept data from any Electronic Cash Register 3, the TxPort 4 connects to the Serial port of the ECR and emulates the printer. This is done by a software component in the TxPort 4 that has the capability to be configured to emulate any printer (internally known as TTY Connect). This software component is set so it knows the technical specifications for the printer, so the Electronic Cash Register 3 is under the impression that the printer 5 is receiving the data. Then, the TxPort 4 analyzes the data and, if the data qualifies as data specified to be stored, stores said data, but also analyzes where the Electronic Cash Register's data ends.

It is at the end point that the TxPort 4 will inject its own data into the data packet sent to the printer 5, adding a specified set of data characters as specified per the TxPort's configuration. For the purposes of this description, this data shall be considered to be a randomly generated lottery number (the algorithm for creating this random number is called the Mersenne Twister and is not part of the invention) that was created at the moment that the POS sends data to the TxPort 4, a control number that serves to guarantee the uniqueness of the transaction, and information related to the lottery draw that this number will participate in. If the TxPort 4 concludes that the data does not need to be stored (i.e. the receipt 6 is an end of day report), the TxPort 4 simply forwards the data to the printer without storing it or injecting any data; it simply acts as a bypass device.

The methodology used by the TxPort 4 to store the data is through patterns that the device identifies in the receipts to be able to tell whether the data is a valid receipt 6 for the purposes that it was configured for or not. These data patterns can be configured as part of the set of rules that control its performance (its profile; this concept will be fully defined in the TxController section) and also include the type of data that the device needs to send to the printer 5 for it to perform its paper cut if that is necessary on that particular printer model.

It also bears mentioning that the TxPort 4 utilizes a novel way of reassuring the system that it is an authorized device connecting to the network with official data. We call this a Tri-Factor Authentication System, and it will be described in detail in its own section as a potential invention on its own.

As shown in FIG. 1, the customer 1 performs a purchase and pays the merchant for the goods that were purchased. The merchant, using the Electronic Cash Register (“ECR”) 3 that he already owns and is already familiar with, performs a transaction. The ECR 3, unaware that it is connected to a TxPort 4, transmits the data that would be printed 5 via a Serial cable connection. The TxPort 4, installed between the ECR 3 and the Printer 5, analyzes the data that was sent from the ECR 3. As it identifies a valid data pattern, it stores the data and retransmits it to the printer 5, injecting its own data at the end of the information of the original data string that it had received from the printer 5.

The receipt 6 obtained from the printer 5 is then delivered to the customer 1, containing all of the data from the original ECR 3 transmission and the data injected by the TxPort 4 printed under the data from the ECR 3. In this particular implementation, the data from the ECR 3 includes the items that were included in the sale, the sub-total of the sale, the taxes that need to be paid for the sale, the total amount of the sale including taxes, and any other text added by the merchant such as surveys and customized greetings. The TxPort 4 recognizes the end of the information from the ECR 3 thanks to the way it had been configured (the device is set up to recognize end of receipt characters and characters that signify that the receipt 6 needs to be cut in the case of an ECR 3 solution that includes a paper cutting printer), and injects its own data into this ECR 3 string, after the receipt ended. At this point the TxPort 4 creates a copy of the full receipt 6 in a raw data format (this copy includes the ECR data and the data it injects into the ECR data). Then, the TxPort 4 communicates with the printer 5 through a Serial cable connection, according to the way it has been configured (there are a multitude of printer communication protocols, security bits, and speeds which fall outside the scope of this document save for the detail that the TxPort 4 can be configured to comply with any setting as needed by the printer), sending the sum total of the data to be printed.

The receipt 6, which includes the sum total of the data from the ECR 3, and the injected data from the TxPort 4 (in this case a lottery number, a control number, draw number, and draw date) is then handed to the customer 1 as an official receipt 6.

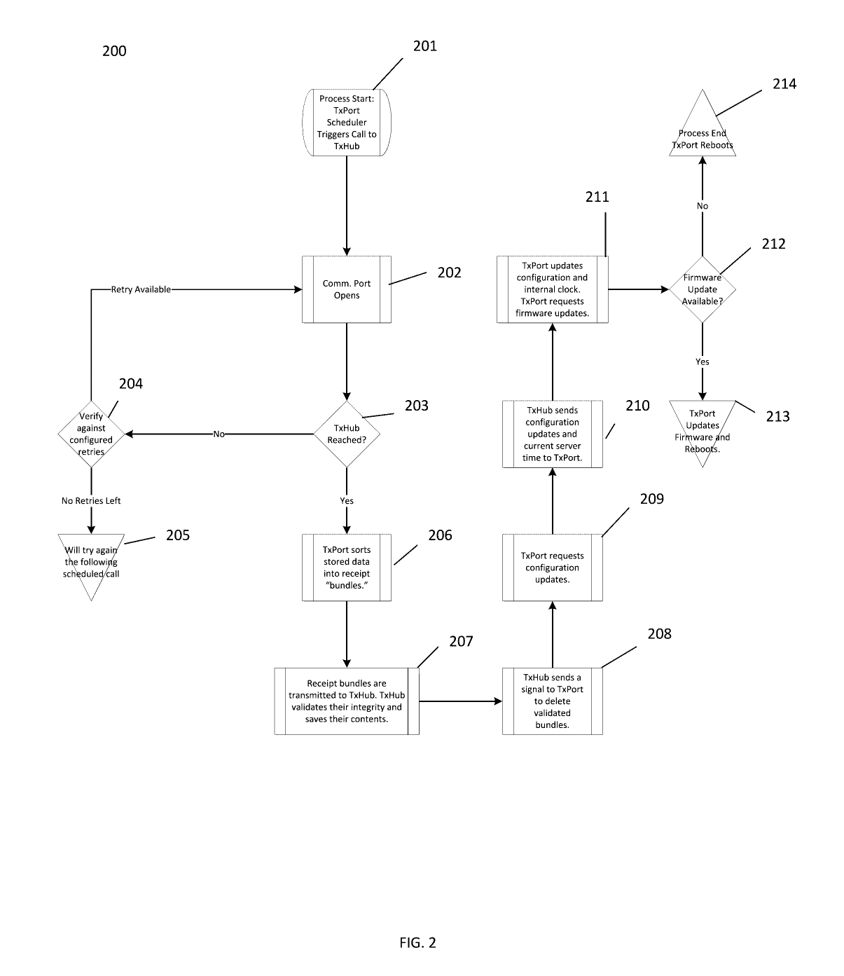

The data that the device stored needs to be sent to the Centralized Data Collection, Sorting, and Forwarding System (the TxHub) 7. This is a separate process that happens as frequently as defined in a configuration file that is sent to the TxPort 4 every time it connects to the TxHub 7. This process will be further explained with FIG. 2. In the case of multiple devices sharing a single phone line 8, they can be configured with an offset schedule so that each device gets its opportunity to finish a transmission before the next device needs to use the phone line.

FIG. 2 is flow chart illustration of an exemplary embodiment of the communication process between the point of sale data, analysis, and reporting device 4 and the centralized data collection, sorting and forwarding system 1 in accordance with the principles of the present disclosure.

During its normal operation, the TxPort 4 will validate the current time in its internal clock against the time it has been configured to perform the communication 201. If it is time to communicate, the TxPort 4 will open its communication ports (202). There is a specific order to go about this, with the TxPort 4 trying all of its available communication interfaces 8, trying the fastest first and the slowest later on if the faster interfaces yielded no result (for lack of a broadband internet connection for instance) 203.

If the TxPort 4 is unable to communicate with the TxHub 7 after using all of its available options, the device will perform a retry 204. How many retries a device attempts is dependent on how many retries it was configured to perform. If it runs out of retries, the device will try to communicate the following scheduled date 205.

When the TxPort 4 reaches the TxHub 7, the device sorts all of the data into receipt “bundles” (a bundle may contain up to 250 receipts) 206 and begins transmitting the bundles 207 to the TxHub 7. During the exchange, the TxHub 7 validates the integrity of the bundle it received against the data the TxPort 4 expected sending via a checksum test. If the checksum matches, the TxHub 7 sends a command to the TxPort 4 so that it may delete the bundle 208. If the checksum does not match, the TxPort 4 retries sending the file until the checksums match.

Once the TxPort 4 is done sending files, it requests a configuration file 209 from the TxHub 7. The TxHub 7 will then send the current profile configuration 210 to the TxPort 4 and the TxPort will update itself 211 with this information, overwriting if necessary. The TxPort 4 will then let the server know the time on its internal clock and the server will update the TxPort's internal clock with its own time, to make sure everything is properly synchronized. At this point, the TxPort 4 will make a final request to the TxHub 7: does it need to upgrade its firmware 212? While this is an uncommon need, the device verifies in case it needs to apply an update. If the answer is yes, the device will proceed to perform a firmware update and reboot itself after finishing 213. If the answer is no, the device will simply reboot and resume normal operations 214.

Further an application programming interface is provided in order to complete a point of sale data capture and reporting method. The Application Programming Interface serves as a virtual Point of Sale Data Capture and Reporting System as Interface Node for a Centralized Data Collection, Sorting, and Forwarding System. The Point of Sale Data Capture and Reporting Method is an application programming interface (“API”) that allows any device to communicate with a virtual TxPort-like device for the purposes of reporting the requested sales data. The virtual TxPort-like device will receive this information and reply with the information that needs to be printed on the customer's receipt in addition to the original transaction information. This method of implementation may remove the need to have a physical device present by the Point of Sale, depending on the needs of the Merchant. Since it is a programming interface, it does require the Merchant or their provider to devise a way to communicate with this programming interface and use its services. Each time that the Merchant's Electronic Cash Register solution sends and requests information from a virtual TxPort device, it needs to pass an authentication check through the TxPort's security provisions before the information can be exchanged.

Currently, there are four different ways to implement this solution:
1. With a physical TxPort 4 present, operating in the Web Services API mode and no network hub in the Merchant's place of business. This sort of implementation would happen through an Ethernet crossover cable instead of a serial cable and is a one-to-one implementation. In other words, there needs to be one TxPort present per Point of Sale.
2. With multiple TxPort's (41-43) present, operating in the API mode and connected through a router, switch or equivalent network hub 300 through Ethernet cables. Each Electronic Cash Register (31-33) in the Merchant's place of business needs to communicate with a specific TxPort through unique authentication credentials. The relationship between Electronic Cash Registers (31-33) and TxPorts (41-43) is a one-to-one relationship, with one TxPort per Electronic Cash Register and Printer pair (51-53).
3. With the implementation of one TxPort Server Edition 400 (also known as TxServer) if there are four (4) or more Electronic Cash Registers 31-34 present at the Merchant's place of business. In this implementation, a single TxPort Server Edition 400 device in the Merchant's network is able to serve multiple Electronic Cash Register's 31-34, obtaining receipt data and generating data for them to send to the printer (51-54) and inject into the receipt. Each Electronic Cash Register (31-34) needs to authenticate with the TxPort Server Edition 400 device with its own unique credentials, which the TxPort Server Edition 400 handles as unique virtual TxPort's interacting with each device being served as a client.
4. With the implementation of the TxPort Hosted Edition 81. The TxPort Hosted Edition 81, also known as TxCloud, is a software only implementation which consists of a web service hosted on the Internet. Electronic Cash Registers 31-34 with close to one-hundred-percent (100%) online capability can make use of this web service to avoid the need for a physical device altogether. Each Electronic Cash Register (31-34) that uses this service needs to authenticate against the TxPort Hosted Edition 81 and the TxPort Hosted Edition treats each client account as a virtual TxPort device.

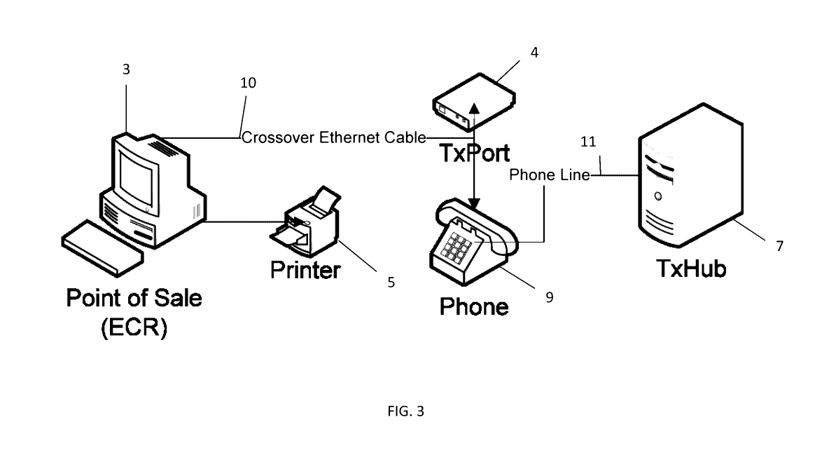

For example FIG. 3, is directed to a single TxPort 4 that has been configured to operate with the Point of Sale Data Capture and Reporting Method is connected directly to an Electronic Cash Register 3 via an Ethernet Crossover cable 10. In this implementation, the Printer 5 is not connected to the TxPort 4 at all, and the TxPort 4 is free to communicate with the TxHub 7 through any means available, even if it's just a phone line 9. The device operates in an offline capacity, storing transactions and the data that has been injected into the receipts to transmit the information, thus reporting when it is scheduled to do so.

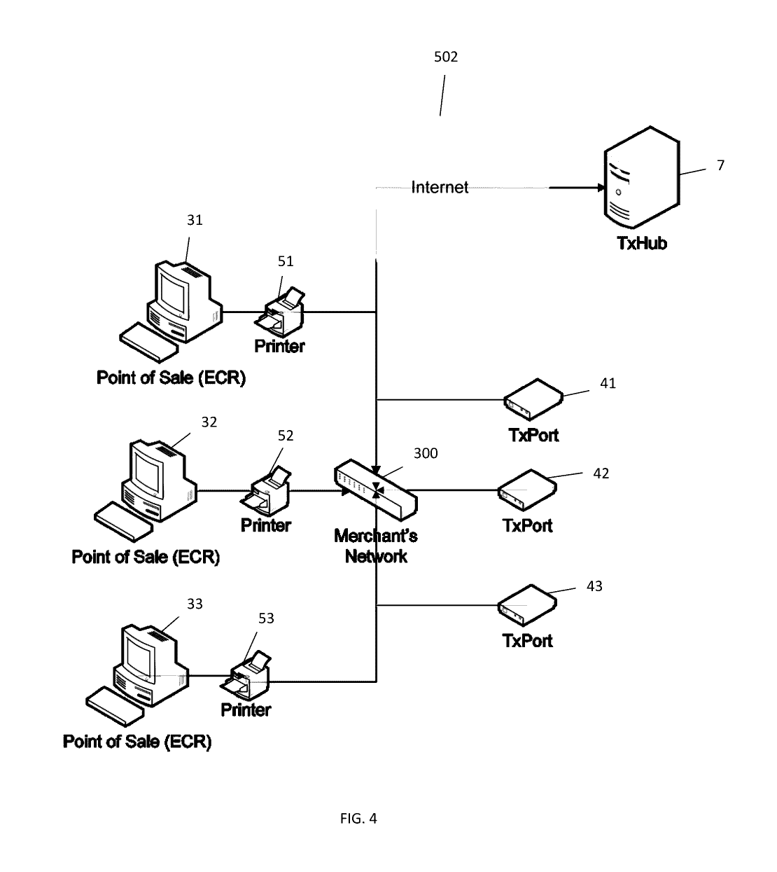

FIG. 4, is directed to the implementation of the Point of Sale Data Capture and Reporting Method, multiple TxPort devices (41-43) being connected to a network hub 300, which in turn is connected to multiple Electronic Cash Registers (31-33). There is no connection between the TxPort (41-43) units and the individual Printers (51-53), which are all connected directly to their corresponding Electronic Cash Registers (31-33).

Each Electronic Cash Register (31-33) needs to have been programmed with the TxPort's static IP Address on the network so that it can find it, and a user account and password with which to authenticate against the TxPort before the devices can communicate. As usual, the devices operate without a permanent connection to the TxHub 7, storing and generating data offline, on the fly. This data will later be reported when the scheduled time to do so arrives. A very important detail is that one TxPort can only serve data to one Electronic Cash Register at a time. It is not possible to have multiple Electronic Cash Registers requesting data from a single TxPort.

Even though this kind of configuration belongs in a network and thus assumes that communication with the TxHub 7 will happen via a Broadband Ethernet connection when the time comes to report the transactions stored in the devices, it is possible to have the network be completely blocked off to the Internet 500 and to have each device communicate with the TxHub individually through a phone line.

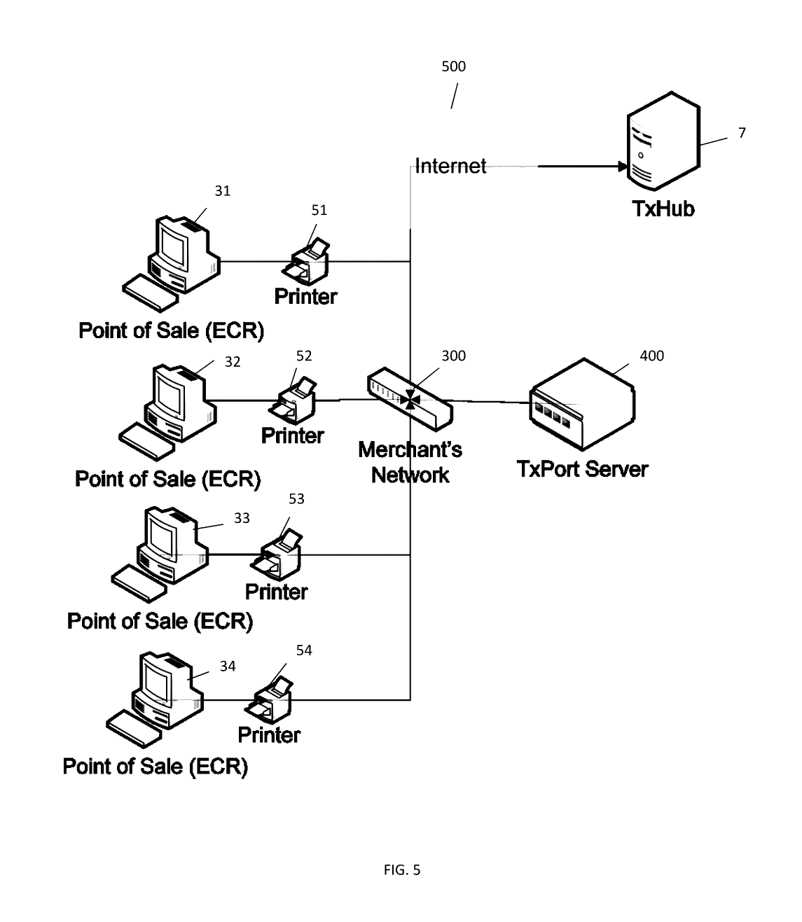

FIG. 5, is directed to the implementation of the Point of Sale Data Capture and Reporting Method being applied to multiple Electronic Cash Registers (31-34) via a single TxPort Server Edition device 400. This device, which will be called TxServer 400 from now on, is a much more powerful implementation of the TxPort operating with the Point of Sale Data Capture and Reporting Method. The TxServer 400 has the power to handle many individual Electronic Cash Registers (31-34), all of which are programmed to act as if they had a TxPort individually installed.

The TxServer 400 has two major components: TxServices and Control Link. Each Electronic Cash Register (31-34) sends a request to the TxServer 400, specifically to its TxServices component, locating it in the static IP that they've been configured to look for the server within its local LAN. The TxServer 400 sends an authentication request and the Electronic Cash Registers (31-34), each possessing an individual user identification and password, all authenticate with their credentials and send the data required by the Method, receiving the data to be added to the receipts from the TxServer.

The Control Link is in charge of communicating with the servers, and to ensure TxServices are running. It frequently polls the TxServices service, and if found not running, it validates de TxServices configuration. If the TxServices configuration is found to be valid, it starts the TxServices service.

Unlike the TxPort 4, the TxServer 400 does not operate via a phone line as this device is configured to communicate with the TxHub 7 much more often than a TxPort 4. The frequency of the connection to the TxHub 7 can be configured remotely. We call this a heartbeat mechanism. The heartbeat runs continuously, but it is only on beats that have been previously defined that the system checks against the TxHub's Messaging Service to determine what to do. The Control Link sends a heartbeat message to the Messaging Service, and the Messaging Service returns a series of actions to the TxServer 400. These actions let the device know what component of the system the device needs to communicate with and what information needs to be shared with these particular components. While the Messaging Service is unable to communicate with the other services and devices, it does lay the groundwork so that the TxServer 400 can do those tasks.

Once the Messaging Service sends instructions to the TxServer 400, the TxServer will perform them in the order that the Messaging Service tells it to. From here on, the TxServer 400 will send packets of information containing its software version, calendar information (necessary to assign the draw dates used for the IVU Loto implementation), and any completed commands from previous heartbeats. If necessary, it may even perform a software update, which might require a restart of the Control Link itself. Most actions are executed in the lifecycle of the heartbeat, with the notable exception of the transmission of bundles. Given that transmission of bundles can take considerable time, it is relegated to a separate lifecycle which runs parallel to the heartbeat mechanism, though it can happen during a heartbeat (for instance, if the transmission of bundles is configured to happen every 30 minutes, and the heartbeat is configured to happen every 15 minutes, the first heartbeat will not include bundle transmissions, but the second heartbeat will happen during the transmission of bundles because 30 minutes have passed).

It is also possible to configure more than one TxServer 400 to serve multiple ECR's (31-34), at a location. This kind of configuration is usually set for critical operations in which redundancy and one-hundred-percent (100%) uptime is an operational requirement. In such an implementation, the devices use a round-robin mechanism to coordinate which device serves the data and if one of them happens to go offline, the remaining device is able to over the full queue for both devices until the affected device can be repaired or replaced.

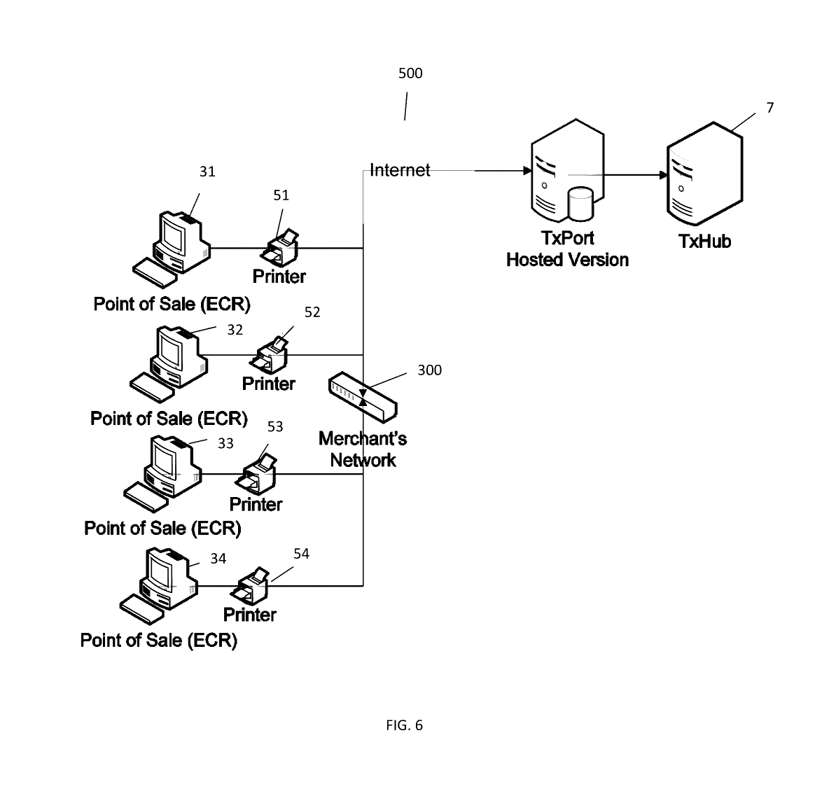

FIG. 6, is directed to the implementation of the Point of Sale Data Capture and Reporting Method via a software solution that is connected to the Internet nearly one-hundred-percent (100%) of the time. We call this implementation the TxPort Hosted Edition or TxCloud 81.

The TxCloud 81 operates similarly to the TxServer 400, but across the Internet 500 rather than a local area network. The TxServices and Control Link components are separated. Multiple TxServices-serving endpoints are published and they all communicate with a single, central datablase.

The Control Link is significantly different. Rather than bundling transactions and sending bundles through FTP, it exposes RESTful web services through which the TxHub 7 can request individual transactions and request deletion of transactions. It also exposes web services to update its configuration, namely Merchant and client ECR information, and draw calendar information.

The TxCloud 81 is the least intrusive of all of the solutions, as the software resides entirely as a Web Service in the Internet and no physical devices need to be installed at the Merchant's place of business. Instead, the Merchant or the Merchant's provider configures a way for their Electronic Cash Registers to connect to the Web Service of the TxCloud 81 and report the sale data to this Web Service. The Web Service in turn generates the information that the Electronic Cash Register (31-34) needs to add to the receipts during the printing process. Each Electronic Cash Register is directly linked its Printer (51-54); the Web Service does not communicate with the Printer (51-54) at all.

Each of the Electronic Cash Registers 31-34 at the Merchant's place of business is configured with the URL of the TxCloud 81 Web Service and proper user authentication credentials consisting of a user name, password, Merchant ID, and an encryption scheme for transferring the data (this encryption scheme will be touched upon in the TxHub section of the document). Once the data is transferred, the TxHub 7 will hold the data in a specialized section that it uses as a Staging Area.

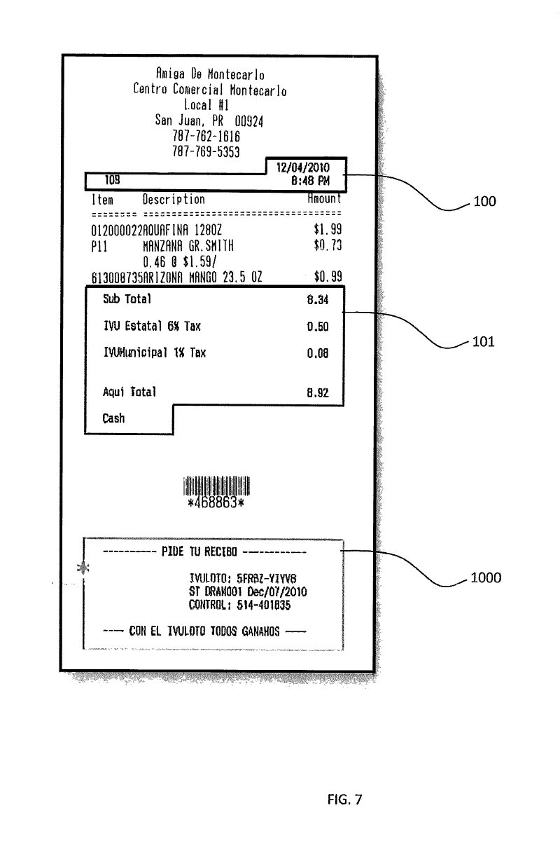

Regardless of the solution implemented, the end result should be a receipt similar to the one shown in FIG. 7. The first and second data blocks (100, 101) come from the Electronic Cash Register. This is the data that the Electronic Cash Register 31-34 sends to the particular implementation of the TxPort 4 at that location. The TxPort stores that data and sends the data in the third data block 1000 back to the Merchant's equipment, to either the Printer or the Electronic Cash Register, depending on the particular implementation being followed at the Merchant's Place of Business.

AS mentioned before, one of the most significant elements of the current disclosure is the TxHub 7. The TxHub 7 is the collection of networked servers and devices that synchronize the efforts of all of the auditing terminals that offer captured Point of Sale Data for the IVU Loto Project.

The TxHub 7 is a system of multiple servers, databases, communication apparatuses, and specialized instruction sets that manages communications among TxPort devices (41-43), TxServers 400, TxCloud data 81, and Sales and Use Tax Reporting Terminals. The TxHub 7 also forwards the captured data to the agency that requested the data to be captured in the first place.

Every TxPort 4, TxServer 400, TxCloud 81, and Sales and Use Tax Reporting Terminal installed ultimately needs to report the information it has captured to a centralized system that can store and interpret this data in order to obtain the information that has been requested of them. In this particular embodiment of the invention, the data that is being collected is Sales and Use Taxes that the Merchant with the device has accrued from their clients and a participation number for a government sponsored raffle that incentivizes customers so that they audit the Merchants by requesting a receipt that has been officially reported to the taxing authority.

In summary, the functions performed by the TxHub may include, but are not limited to:

Authenticating Devices

Organizing Captured Data

Interpreting Captured Data

Storing all the Captured Data and Sending it to the Client

Handling the TxServer's Messaging Service 424

Providing a link from the user interface, TxController 800, to the Central Database CB

There is a separate component of the TxHub 7, the TxController, that will be described in its own entry as it possesses a great deal of unique processes for allowing end users to interact with and control the TxHub 7 and the devices that connect to it.

As the TxHub's 7 components may change depending on data and communication requirements, this document will focus on the processes and functions performed by the TxHub 7. It is these functions and processes that should be considered as the TxHub 7, and as possible candidates for undergoing a patent process.

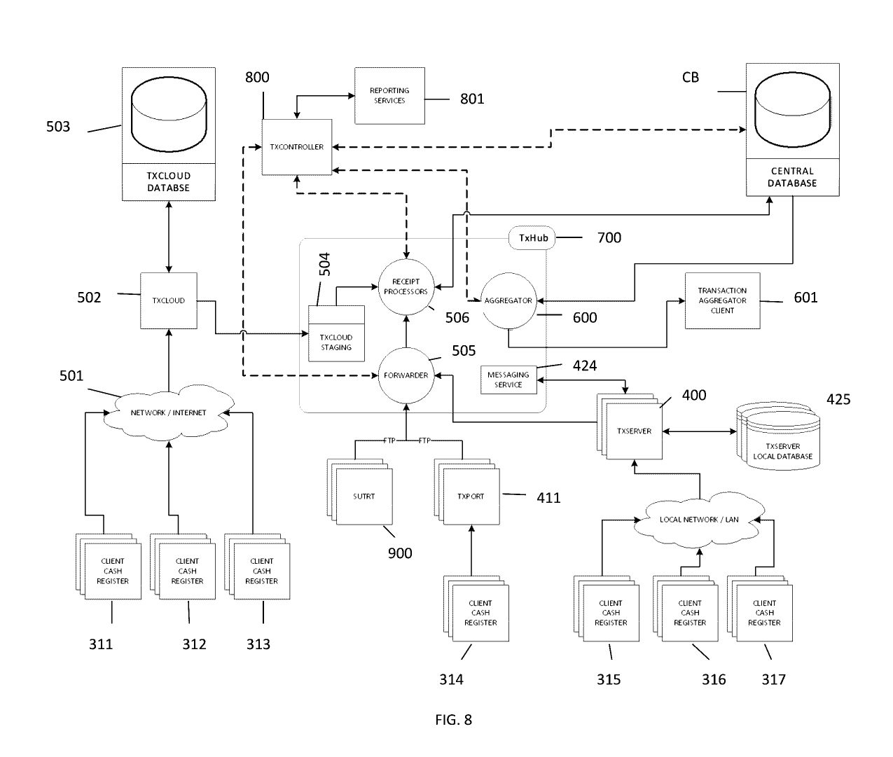

FIG. 8 discloses an exemplary diagram of the interaction of the Tx Hub 7. The TxHub 7 is in the middle and all of the external components that interact with it surrounding the TxHub 7, with arrows displaying the direction of information flow. This diagram exposes the TxController 800, which is basically the user interface to the entire operation and one of the most important components of the entire System. It will be explained in detail later.

The first point of the TxHub 7 that interacts with the data obtained from the devices is usually the Forwarder 505. The first point of the TxHub that interacts with the data obtained from the devices is usually the Forwarder. For example the data obtained from the devices may include the same structure disclose in FIG. 3 to FIG. 6. In the exemplary embodiment includes a single TxPort 4 connected directly to an Electronic Cash Register 3 and a SUT Reporting Terminal Devices 900. Also includes multiple Electronic Cash Registers 3 connected to TxPort Server Edition device 400 comprising a Txserver Data base 425. Further a multiple Electronic Cash Registers 3 is connected to the TxCloud 502, having a Txcloud data base 503, wherein said TxCloud 502 across the Internet/network 500.

From there on, the data goes through the various components of the system, starting with the Receipt Processors 506. In case that the processing fails for some reason as explained in the previous figures, the TxController 800 can connect to the Receipt Processors 506 and through user intervention correct the receipts that the Receipt Processors could not process correctly. Once the receipts are properly processed, they get sent to the Central Database CB for storage and the Central Database CB sends those receipts to the Aggregator 600, which sends them from the TxHub towards the Transaction Aggregator Client 601, which is the output point of the entire operation. The Transaction Aggregator Client 601 can be any component designated by the customer that subscribed to use the system, and the file is sent in a format that the customer subscribed to use the system can utilize.

When a receipt fails to process for some reason, the user intervention process requires the UI, which is the TxController 800. The user, aided by the TxController (which displays which receipts require user intervention in one of its modules) is able to retrieve the receipts from a section of the Central Database CB that flagged bad receipts (as catalogued during the processing steps) and send them again to the Receipt Processors 506, performing additional manual checks to fix the problem with the receipts. Further the TxController 800 may generate reports of services 801.

The following processes are followed by the TxHub 7 and the devices that connect to it:

Security Validation (Tri-Factor Security)

The TxHub 7 uses a Tri-Factor security scheme to validate that the devices that connect to it are authorized to perform the communications that they are initializing. There are three main components to the Tri-Factor security method: a public PGP key, a private PGP key, and a Certificate Authority that sends a Security Certificate to the TxPort whenever the TxPort performs a Certificate Signing Request (CSR). All of the data in the TxPort is encrypted in such a way that it can only be opened by the proper key. In this case, that key is the Security Certificate that is stored in the TxHub's Certificate Authority. Whenever a TxPort communicates with the TxHub, the TxHub's Receipt Processors will need to use the stored certificate to open the data from the TxPort. Thus, the Tri-Factor security depends on the TxPort being able to go through the security challenges presented by the TxHub through its use of private and public encryption keys (PGP in this implementation), and then the data still can't be read by the TxHub unless it uses the correct certificate. Each TxPort has its own certificate assigned, and the TxPort requests new certificates periodically for security purposes.

Data Forwarding

After the identity of a device that connected to the network is confirmed, the device will transmit the receipt bundles they've accumulated to a File Transfer Protocol (FTP) server that performs an initial storage of these bundles so as not to overload the queues being serviced by the Receipt Processors. The Forwarder 505 is a service that periodically forwards receipt bundles from the FTP's storage towards the end of the Receipt Processing queue. Thus we can define that one of the very first steps that the TxHub 7 needs to perform is to manage the movement of the stored receipts towards the working phase, which is the Receipt Processing phase.

Receipt Processing

The main function of the Data Capture devices and Method is to forward the data they obtained from the Point-of-Sale to the TxHub so that this data can be analyzed and the information required of it be extracted. In order to perform this intensive processing, the TxHub 7 contains multiple components dedicated to processing receipts. These Receipt Processors 506 are able to manage receipts from multiple solutions that adhere to the TxHub's specifications. The receipt processors are also prepared to handle multiple operations, depending on the necessities of the receipts being analyzed. These operations are: decrypting encrypted receipt bundles, properly parsing and processing receipts, reprocessing receipts in the event of an unexpected resolution when parsing receipts on the first pass, and obtaining receipts from the TxCloud Staging 504 area.

Data Storage

The TxHub possesses a powerful Central Database CB that stores all of the information regarding operations, terminal profiles, Merchant ID's, receipts, receipt states, communication logs, etc. This Central Database CB also possess multiple functions to share the data with the multiple components as necessary, and also sends the data to its final destination within the TxHub 7, the Aggregator 600.

Transaction Aggregation

The Aggregator 600 is a component that collects all of the data that the system has extracted from the Central Database CB and formats it as required by the customer that subscribed to using the system. The Aggregator 600 is able to match the different Merchants, their corresponding devices, and the data that was captured by the system, regardless of whether that data was generated from a device located in the Merchant's location or from the TxCloud Web Service.

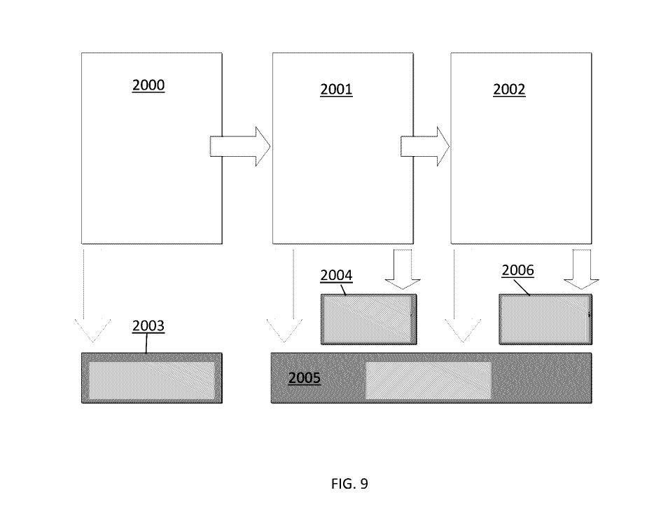

FIG. 9, is directed to the High-level View of the Receipt Processing Queue. When the bundled receipts move from the FTP to the Receipt Processors, they must first go through the Bundle Validation and Processing stage 2000. Once the bundles clear this stage, the state of each bundle is saved in a special storage section 2003. At this point, the receipts enter the Receipt Validation stage 2001. Each bundle's resulting state is documented and the IVU Loto 2005 numbers obtained are taken from the receipt. The receipts 2004 then proceed to the Receipt Processing stage 2002, in which they will be stored as valid receipts to be dispatched to the client or they will be stored as invalid receipts to be reprocessed later 2006.

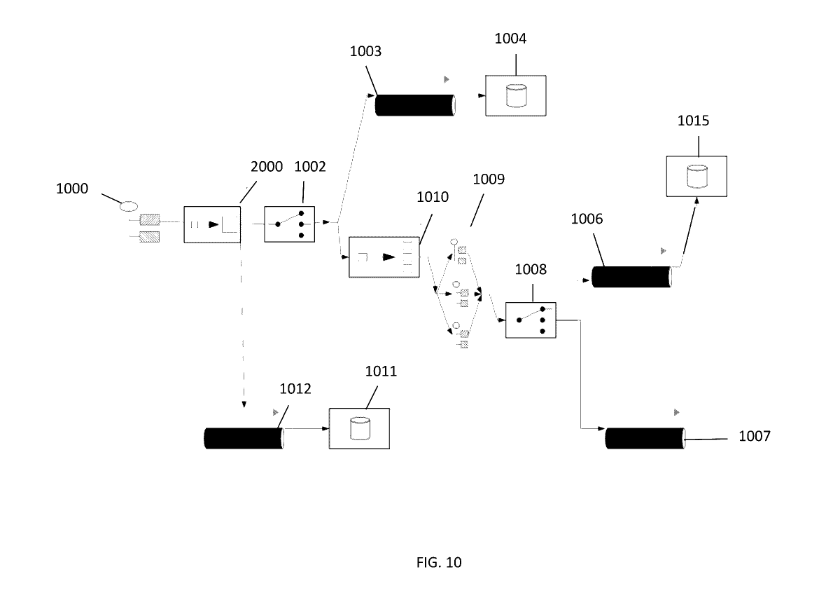

FIG. 10 through FIG. 12 shows the process at the different stages. For example FIG. 10, when the bundle 1000 is originally forwarded to the Receipt Processors, the Receipt Processor will initiate its Bundle Validation Process 1000. As the Bundle Validation Process runs, the TxHub stores the state of each bundle in the Raw Bundle State storage 1001 as the bundle is sent to the Bundle Status Router 1002. The Bundle Status Router 1002 sends the bundle to the Invalid Bundle Queue 1003 and consequently to the Invalid Bundle Storage 1004 if a problem occurred so that the contents of the bundle could not be opened. Bundles in Invalid Bundle Storage 1004 will get reprocessed once the proper key to open them is located. If the there is no problem with the bundle and the Processor can open its contents, the Receipt Bundle Splitter 1010 will start separating each and every receipt and sending them to the Receipt Router 1008. The Receipt Router 1008 will first search for the status of the device that sent the bundle. If the device which originated the receipts 1009 is not configured, the receipt goes into the Unconfigured Receipt Queue 1006, to be stored in the Unconfigured Receipt Storage 1015 for reprocessing later when the proper configuration for that receipt is found. If the receipts have a valid configuration associated to the device from which they originated, the receipts are sent to the Receipts Validation Queue 1007.

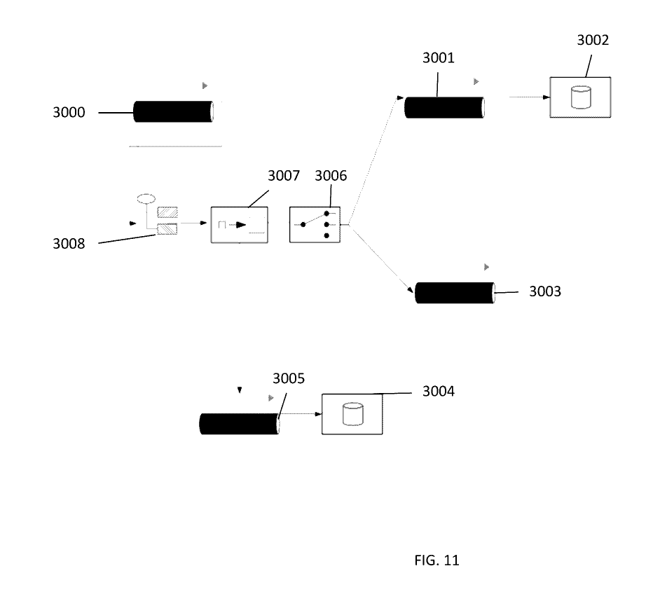

Further, as shown in FIG. 11, the Receipt Validation Queue 3000 needs to compare the receipts 3008 obtained against the expected interpretation according to the record of the device that produced the receipt within the system. Basically, for each receipt within the system, the Processor needs to assess if it can read them to obtain the requested information (in this implementation, it would be the subtotal of the transaction, the 6% tax value, the 1% tax value, the receipt's total, its corresponding IVU Loto Number, Control Number, and the Draw Date and Draw Number). If it can't identify that the receipt contains the parameters necessary to read it, the receipt is sent to the Invalid Receipt Queue 3001 which will forward it to the Invalid Receipt Storage 3002 to be reprocessed later. If the information appears to be valid, the system will send the receipt to the Receipts Parsing Processing Queue 3003.

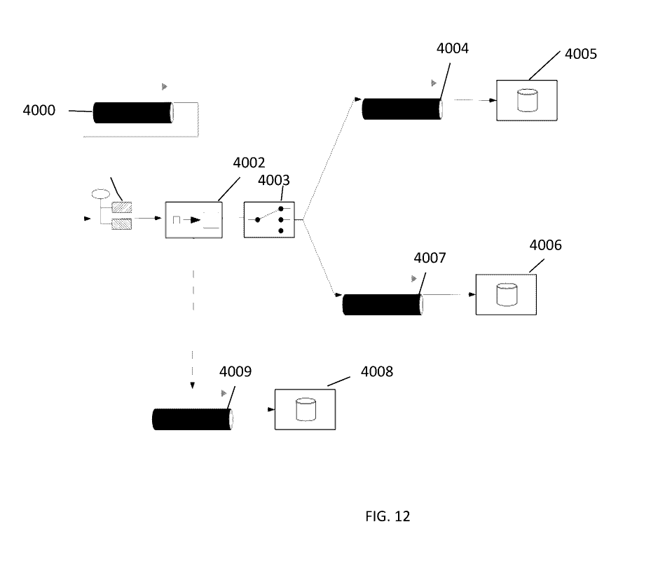

At this point in the process, as shown in FIG. 12, the system has concluded that the device that captured the receipt is properly configured and the system has a profile that allows it to interpret the information in the receipt. The system has also concluded that the receipt contains all of the data that the parsing configuration associated to it has defined, so it will attempt to read the receipt and separate the data into each separate category (within this implementation, the categories are: subtotal, total, 6% tax, 1% tax, IVU Loto Number, Control Number, Draw Number, Draw Date). The system will send the state of each individual receipt towards the Receipt State Queue 4009, which will later store it in the Receipt State Storage 4008. Then the Receipt Status Router 4003 will either send the receipt to the Parsing Failed Receipt Queue 4007 if the parsing failed, and the Parsing Failed Queue 4004 will send the receipt to the Parsing Failed Receipt Storage 4005 for reprocessing. If the parsing operation is successful, the receipt is sent to the Parsed Receipt Queue 4007, which will later store the receipt in the Parsed Receipt Storage 4006. It is from this Parsed Receipt Storage 4006 that the TxHub 7 later forwards the receipts with all of their properly classified data to the Aggregator, a system that will later communicate the data to the client.

As mentioned before there is a separate component of the TxHub 7, the TxController 800 which possesses a great deal of unique processes for allowing end users to interact with and control the TxHub 7 and the devices that connect to it. The TxController 800 plugs into the multiple databases and systems that compose the TxHub in order to monitor and control them, hence its name. One of its most important components is its web-based Graphical User Interface, which allows any authorized user with an internet connection to connect to it and manage the area of operations for which the user is authorized to do so.

Managing the entire TxHub 7 system and all of the devices that communicate with it continuously, manually verifying bad receipts and fixing them, performing diagnostic checks, requesting reports, basically every function that would be required to keep control of the solution would be a tremendous undertaking. That is why the TxController 800 was designed along the multiple systems that share information within the TxHub 7.

The TxController 800 also includes functions to manage and control the human element working on the configuration and deployment of devices. There is a mobile version of the TxController 800 that runs on mobile operating systems that record the location and time of the field technicians that are performing new installations or offering support to Merchants that already have their TxPort or SUT Reporting Terminal Devices.

Another interesting detail about the TxController is how it integrates with the SUT Reporting Terminal Devices. The SUT Reporting Terminal Devices are very different from the TxPort derived devices and solutions, however the TxController is able to configure and manage them as well. This makes the TxController an extremely versatile and powerful tool that can handle not just the functionality required of the IVU Loto program, but many other tasks that require a main platform that can remotely manage and control any number of countertop terminals.

The multiple components that make up the TxController for the purpose of managing the TxHub are the following:

Receipts Module

Reports Module

Service Module

Merchant Record Module

Device Profile Module

Device Inventory and Management Module

TxWeb Services Module

Personnel Module

Device Updater Module

Aggregator Control Module

User Permissions Module

For the purposes of this definition, the most important modules are the Receipts Module, Device Profile Module, Device Inventory and Management Module, TxWeb Services Module, Device Updater Module, and the Personnel Module.

Receipts Module

The Receipts Module allows the TxController user to verify, manage, and analyze data captured in the receipts within the system. These are virtual copies of the receipts captured by the TxPort. The system allows the user to search for receipts based on multiple criteria, such as the date of the transaction, the date the transaction was received at the TxHub, the city of the Merchant that produced the receipt, its IVU Loto Number, etc.

One of the most crucial functions of this module is that it also allows the user to search by Receipt Status. The various states of the collected receipts may include Invalid Receipts that need to be fixed by the TxController use. In this sense, the TxController allows the user to access the Receipt Processors for the purposes of reprocessing receipts, fixing parsing misinterpretations among other problems.

Reports Module

The Reports Module depends on the separate Reporting Service being available. Like many tools found within the TxController, the Reporting Service is a separate module that permits access through the TxController. This module allows the user to request a multitude of reports from the system, including but not limited to which merchants are currently subscribed to the system, which devices (or virtual terminals) correspond to them, how many transactions are performed on a daily basis, tax totals from Merchants, which devices are currently considered to be up-to-date and which are not properly transmitting. All of this information doesn't just allow the system to offer information; it also allows the users to design proactive maintenance and auditing measures.

Service Module

The Service Module is one of the most extensive modules in the system, allowing users to design and plan routes for performing new installations or support visits. The Service Module is composed of several sub-modules such as the mapping module which analyzes Merchant's addresses and converts them to GPS coordinates for assisting technicians in locating their locations. This works in tandem with the mobile application in order to fix GPS errors, updating the system with the proper coordinates once a technician successfully finishes a service or installation order at the Merchant's location.

The Service Module also keeps track of all of the technicians and which orders they're working on, the incident numbers for service orders, and all of the situations that technicians may have run into while offering support or installation services.

Merchants Record Module

The Merchants Record Module maintains a record of all the Merchants subscribed to the system and their current installation and service states.

Device Profile Module

The Device Profile Module is one of the most extensive of all the components within the TxController. Unlike the Merchants Record Module, the Device Profile Module deals with the records of devices or virtual terminals that have been configured to belong to a particular subscribed Merchant.

Due to the great variety of Electronic Cash Registers 41-43 out there and the conditions found within different Merchants, the Device Profile Module has to accommodate many different situations and requirements. It is also important to note that due to the way Electronic Cash Register and Printer pairs are configured, once a particular configuration is properly set, it should work with all iterations of that particular configuration. It should also be noted that the system has been designed to handle a virtually endless amount of merchant and device records, so the Device Profile Module needs to have multiple tiers or configurability that may need to be set to work globally or on a per-device basis. In order to meet these challenges, a particular kind of inheritance was developed for the TxController.

FIG. 14 is directed to TxController inherence diagram. When designing the TxController 800, one of the challenges where how to create a system that has the capability to manage so many different devices with different communication and device parameters? How can such a system be consistent, extensible, and effective for the user to define? The answer to this question was in the inheritance system designed for the TxController. Inheritance systems are not new in software development, but the way the TxController 800 can grab inheritance from either a pure parent-child relationship or plainly from an entirely different object outside that parent-child relationship so it can be included in its profile is a novel way of managing inheritance in such a large scope. For this system we can use multiple nodes to feed into a single end node.

The figure shows how a single profile, represented as the “Resulting Node,”5003 can receive properties from multiple profiles, represented as “Parent Node” 5000 and “Child Node” 5001,5002. However, in order to manage property conflicts and individual customizations, a system is put in place where the last node in the chain will have precedence if a particular attribute is defined in multiple nodes.

Rules of Inheritance:

As an exemplary embodiment for the rules of inherence the topmost level passes values to the lower only if the lower levels do not have does values explicitly defined. For example, Attribute 1 was not defined in the Parent node 5000. This Child Node's value would overwrite it anyway. Attribute 2 is not defined in this Child Node, so it inherits the value passed from the Parent Node 5000 so far. Attribute 3 is defined in this Child Node so it keeps the value within it. Attribute 4 is not defined in this Child Node, so it inherits the value from the Parent Node. Attribute 5 is defined in both nodes, but the Child Node's value takes precedence when that happens.

This Child Node 5001,5002, found at a lower level than the previous Child Node will take the precedence if it has values defined in it. Attributes 1,2,3 and 4 are not defined, so they inherit the attributes in the previous Child Node. Notice that Attributes 1 and 4 are not defined in the previous Child Node, so they will inherit the value form Parent Node. Attribute 3 has the same value in both nodes, so it remains the same. Attribute 5 has a different value in this Child Node, so it will take precedence over the vale in the previous child Note.

The Resulting Node 5003 is how the profile will behave, after it decides which values to inherit from the nodes that precede it. In essence, this is the actual profile. Attribute 1 has a value of A, inherited from the first Child Node. Attribute 2 has a value of X, inherited from the Parent Node as neither Child Node overwrote it. Attribute has a value of B, which is the same value found in both Child Nodes. Attribute 4 has a value of Z, which come from the Parent Node and was never overwritten. Attribute 5 has value of E. every node has value for Attribute 5; in such a case, the value that is inherited is the one from the node at the bottom of the stack

Let's use an example relevant to the IVU Loto program to illustrate the idea. A particular device, a TxPort, would be the last object in the chain. The Puerto Rico Department of Treasury would be the highest object in the chain; the top parent node so to say. There are multiple attributes that exist within a profile that can define the way a device performs and defines data. Some of these attributes are:
Commonwealth of Puerto Rico SUT Tax: the sales and use tax amount the central government expects from every transaction, which is currently set at 6%.
Municipal SUT Tax: the sales and use tax amount the municipal governments expect from every transaction, currently set at 1% on most municipalities.
Printer Baud Rate: the transfer speed rate that a TxPort expects to receive information from an Electronic Cash Register.
Printer Handshake Mode: defines the method used by the ECR and the Printer to request and clear data being transferred from the ECR to the printer.
DHCP: defines whether the TxPort will use the DHCP Server to receive an IP from the local network when configured within a LAN, or if the device will require a static IP Address.
Testing Mode: defines whether the data captured by the device should be sent to the Aggregator or not; this is used during initial development against a new kind of implementation to avoid sending fake data generated during testing cycles.

The top profile from the Department of Treasury of Puerto Rico has those attributes defined as the following:

Commonwealth of Puerto Rico SUT: 6%

Municipal SUT: 1%

Printer Baud Rate: 9600

Printer Handshake Mode: RTS/CTS

DHCP: Enabled

Testing Mode: Yes

There are many more values, but we will use those for the purposes of illustrating the inheritance mechanism.

When we create a brand new profile, let's say this is a profile for a first municipality i.e. Municipality of San Juan, we may choose not to touch any of the values. This means the values in the Municipality of San Juan remain exactly as they are in the top profile of the Department of Treasury of Puerto Rico. Then we configure a brand new store in the Municipality of San Juan, let's call it Softek Diner. The profile for this new store will contain the following information:

Printer Baud Rate: 19200

Printer Handshake Mode: Keep Alive Active

DHCP: Enabled

Testing Mode: No

Since the values for the attributes Commonwealth of Puerto Rico SUT Tax and Municipality Tax are not defined in this profile, nor in the Municipality of San Juan profile, the Softek Diner profile uses the values in the profile for the Department of Treasury of Puerto Rico, which is 6% for Commonwealth of Puerto Rico SUT and 1% for Municipality SUT. The DHCP value is the same as in the Department of Treasury of Puerto Rico, so there is no conflict and it remains the same (Enabled). We do have conflicts on Printer Baud Rate, Printer Handshake Mode, and Testing Mode. Since the values for the Department of Treasury of Puerto Rico are the ones at the top of the stack, they are would be the values in those attributes if those attributes had not been defined. However, they are defined in the value for the Merchant, which is a lower level, and when there is an attribute value conflict, the lower level always takes precedence over the higher levels. This means that the values on those attributes are now set to Printer Baud Rate: 19200, Printer Handshake Mode: Keep Alive Active, and Testing ModeNo.

That would be the value that every new TxPort would inherit when configured at Softek Diner. However, each new TxPort exists in its very own profile, so in order to continue with the explanation let's say that the merchant has two separate networks in the store. One network has DHCP Enabled, but the other network, which is the one where the main cash register is located, has DHCP Disabled for security purposes and sets static IP addresses. When a TxPort is configured to interact in that network, the TxPort must have the DHCP Disabled as well (and a manual IP address must be defined, but that's a separate attribute we won't be using in this example). In order to do that, we won't touch the Softek Diner profile, as it would mean every TxPort at Softek Diner would have DHCP Disabled. Instead, we locate the profile for the specific TxPort that must have DHCP Disabled. It would take a long time to configure every single value in that TxPort, so instead of configuring every value, the only one we need to modify is the DHCP value and change it to Disabled. Every other attribute will have values that were passed down from the Merchant profile, Softek Diner first, then from the Municipality of San Juan, and then from the Department of Treasury of Puerto Rico. If a value does not need to be modified from a particular level of the inheritance stack, it won't be modified in order to keep things convenient and easy to manage. We'll use a new example to illustrate this.

Let's say that a few months have passed, and the Municipality of San Juan comes up with a ruling in which they'll raise their own taxes from 1% Municipal SUT to a 2% Municipal SUT. The profile for the Department of Treasury of Puerto Rico has Municipal SUT defined as 1% and we don't want to change that value as other municipalities are remaining at 1%. We had placed a Municipality of San Juan profile that had no values set in its attributes in the previous example between the Department of Treasury of Puerto Rico and this particular Merchant. This means that instead of risking damaging all profiles that belong to Softek Diner and changing Municipal SUT to 2% in it (as there may be other Softek Diners in other municipalities that remain charging 1% SUT), or going through the tedious labor of modifying every single device profile for every TxPort in every Merchant in San Juan, all we need to do is go into the Municipality of San Juan profile and change the Municipal SUT Tax attribute to 2%. Since the Municipality of San Juan was placed below the Department of Treasury of Puerto Rico when we configured the Merchant Profile for Softek Diner in San Juan, the 2% Municipal SUT takes over from the 1% Department of Treasury of Puerto Rico Municipal SUT at 1%. Since we did not define a Municipal SUT value in the profile for the Softek Diner merchant record, it simply takes the 2% defined in the Municipality of San Juan profile. Since we also didn't define Municipal SUT in the devices within the Softek Diner record, they inherit from Softek Diner record which is inheriting the 2% Municipal SUT from San Juan. The real power comes from the detail that if a record for a Softek Diner is created in a second municipality, such as Caguas, it will inherit from a Municipality of Caguas profile record, which is in turn inheriting from the Department of Treasury of Puerto Rico record which has Municipal SUT set at 1% so every Softek Diner from the Caguas municipality can meet with the 1% Municipal SUT value required in Caguas while very Softek Diner in the San Juan municipality will meet with the 2% Municipal SUT value required in San Juan even if all the ECR's and Printers in both merchant records inherit from the same Softek Diner profile. That's why we didn't define taxes at that level of the inheritance stack.

It is also possible for different merchants to inherit certain data from each other. Let's say that there's a different Merchant, Ankh Diner in Guaynabo. They're not related to Softek, but they use the same ECR's and Printers. Instead of going through the trouble of defining a new Ankh Diner profile which would have the same information as the Softek Diner profile, we would import the inheritance stack from Softek Diner into Ankh Diner. Then we'd simply make the individual changes required at a lower level within the Ankh Diner profile so values such as Merchant ID match with it instead of Softek Diner. The system has enough flexibility that as long as the values are defined only in the required places (for instance, don't define Tax values in profiles we need for technical reasons), we can import any profile within any other profile and reap the benefits of having the configuration values the new profile needs. All we need to do is perform any specific modifications for that particular profile at the lowest end of the inheritance stack.

Device Inventory and Management Module

The Device Inventory and Management Module of the TxController is able to keep an accurate, up-to-date listing of all the devices being used in the solution, even if they're not configured for a particular Merchant yet. This module also allows us to monitor the communication messages that the devices exchange with the TxHub whenever they connect to it, allowing the user to diagnose the device's behavior and plan preventive service strategies.

The most basic functionality in this module is to keep a record of all the serial numbers of the devices, paired to the logical identifiers that have been assigned to them whenever they are configured as part of a record and other information that can be used to identify the devices, such as their MAC address. This functionality extends to keeping a full history of the device from every time it's been installed and removed, where it was installed to, who installed it, who removed it, what service order prompted its removal or its installation, what version of the software it holds, which entity owns the device, when was the last time it communicated with the TxHub, from which purchase order was the device acquired, is it located in our inventory, the customer's, or installed on a Merchant's business, if it has auxiliary equipment installed (such as s SIM card), which is the serial number of that auxiliary equipment that's attached to the device, etc.

The data can be entered manually, device by device and updated as necessary or entered through an imported Excel or Comma-Separated-Values file that conforms to the system's standard. The location of the devices is maintained automatically as installation and service orders are fulfilled, though users with enough privileges can modify the records as necessary.

There is also a functionality assigned to this module that allows the user to verify all of the communication messages generated by the devices as they communicate with the TxHub. This function allows users to check the different transmission messages that the devices produce during communications, enabling them to identify if a particular device needs to be replaced before a service order comes through. These transmission lines include simple status messages, such as a line that describes the software in the TxPort and the versions of the different software components (such as the version of the TTY Connect component). It is through these messages that we can identify if a TxPort did not successfully received a new security certificate, if the device's internal clock is failing, the amount of receipt bundles in the device at the time of communication, etc.

It will be apparent to those skilled in the art that various modifications and variations can be made to the method and system described in the present disclosure. Other embodiments of the method and system will be apparent to those skilled in the art upon consideration of the specification and practice of the method and system disclosed herein. It is intended that the specification and examples be considered as exemplary only, with a true scope of the disclosure being indicated by the following claims.

What is claimed is:

1. A point of sale tax reporting system for automatically reporting sales taxes, the system comprising:
a retail printer and an electronic cash register comprising a first processor, wherein the retail printer and the electronic cash register are part of a pre-existing system, wherein the first processor is configured to send a print data to the retail printer, the print data comprising a format readable by the retail printer, the print data further comprising an end;
a centralized data gathering system comprising a second processor and an indexed data storage, wherein the second processor is configured to store and retrieve a retail purchase data using a unique control number as index; and
a payment processing system comprising a local data storage and a third processor operatively coupled between the electronic cash register and the retail printer, wherein the third processor is configured to intercept the print data from the electronic cash register and modify the print data by executing the steps of:
recognizing the end of the print data,
extracting the retail purchase data from the print data, the retail purchase data comprising at least a first sales transaction data and a sales tax data,
generating the unique control number based on the retail purchase data,
storing the unique control number and the retail purchase data on a local data storage,
obtaining a modified print data by injecting the unique control number to the print data,
sending the modified print data to the retail printer for printing of at least a receipt, and
sending the unique control number and the retail purchase data to the centralized data gathering system, wherein the centralized data gathering system receives the unique control number and the retail purchase data and stores the retail purchase data in the indexed data storage using the unique control number as index.

2. The system of claim 1, wherein the payment processing system is configured by a remote configuration authority.

3. The system of claim 2, wherein the remote configuration authority is the centralized data gathering system.

4. A point of sale tax reporting method for automatically reporting sales taxes, the method comprising executing on a processor the steps of:
sending, by an electronic cash register, a print data to a retail printer, the print data comprising a format readable by the retail printer, the print data further comprising an end, wherein the retail printer and the electronic cash register are part of a pre-existing system;
intercepting, by a payment processing system operatively coupled between the electronic cash register and the retail printer, the print data from the electronic cash register and modifying the print data by further executing on a processor the steps of:
recognizing the end of the print data,
extracting a retail purchase data from the print data, the retail purchase data comprising at least a first sales transaction data and a sales tax data,
generating the unique control number based on the retail purchase data,
storing the unique control number and the retail purchase data on a local data storage,
obtaining a modified print data by injecting the unique control number to the print data,
sending the modified print data to the retail printer for printing of at least a receipt, and
sending the unique control number and the retail purchase data to a centralized data gathering system, wherein the centralized data gathering system receives the unique control number and the retail purchase data and stores the retail purchase data in the indexed data storage using the unique control number as index.

5. The system of claim 4, wherein the payment processing system is configured by a remote configuration authority.

6. The system of claim 5, wherein the remote configuration authority is the centralized data gathering system.
